(19) United States
(12) Patent Application Publication
(10) Pub. No.: US 2007/0272725 A1
(43) Pub. Date: Nov. 29, 2007

(54) Soldering Iron

(76) Inventors: Ralf Zerweck, Boennigheim (DE); Volker Munz, Pfaffenhofen (DE)

Correspondence Address: COATS & BENNETT, PLLC, 1400 Crescent Green, Suite 300, Cary, NC, 27518, US

(21) Appl. No.: 11/569,623

(22) PCT Filed: Apr. 4, 2005
(86) PCT No.: PCT/EP05/03526

§ 371 Date: Jul. 9, 2007

(30) Foreign Application Priority Data
May 26, 2004 (DE) 20 2004 008 391.4

(51) Int. Cl. B23K 3/00

(52) U.S. Cl. 228/51; 228/55

(57) ABSTRACT

Disclosed is a soldering iron comprising at least one replaceable soldering tip and a tip holder which supports the same and is provided with a handle section and a terminal housing section that adjoins the tip holder. In order to be able to remove a soldering tip from the remainder of the soldering iron in a simple structural manner without using additional tools, the tip holder (3), along with the soldering tip (2), is embodied as a detachable module (5) which can be removably connected to the terminal housing section (4).

The invention relates to a soldering iron with at least one interchangeable soldering tip and a tip holder which holds it and has a handle section, and an end housing section which connects to the tip holder.

With soldering irons known from practice there is sometimes the possibility of releasing the soldering tip from the tip holder. Consequently, the soldering tip can be replaced by a different soldering tip. This occurs, for example, when the soldering tip is worn.

In this respect it should be noted that this kind of replacement is only possible with appropriate tools or only after the soldering tip has cooled down.

The object of the invention is to improve a soldering iron of the type quoted in the introduction such that a soldering tip can be released from the rest of the soldering iron without any additional tool in a constructively simple way and in a short time.

This object is solved by the features of claim 1.

According to the invention the tip holder together with the soldering tip can be released from the replacement module which can be connected to the end housing section. This means that it is not the soldering tip itself which is released, but rather the tip holder holding it which is released from the rest of the soldering iron, i.e. from the end housing section, for replacing the soldering tip. Since the tip holder is formed with an appropriate handle section, it can be used both for releasing the tip holder as well as for the prevention of injury by a soldering tip which is still hot. A separate tool for the replacement of the soldering tip is not required.

Depending on the use of the soldering iron, there is the possibility that different soldering tips of different material or with different dimensions can be used. Suitable soldering tips can be made available by various replacement modules, so that during a soldering process the soldering tips are interchangeable in a simple and safe way by using a different replacement module. Also in this connection, no separate tool is required nor is it necessary to wait until the soldering tip has cooled down. In principle, changing the replacement module is possible with the soldering iron in on-going operation.

According to the invention, it should be noted that the tip holder with handle section generally exhibits a larger diameter than a corresponding soldering tip, so that due to this larger diameter the tip holder can be handled more simply manually and can in particular be released or attached again to the soldering iron. On account of the larger diameter, also greater forces can be applied both when releasing and when attaching the tip holder to the rest of the soldering iron.

There is the possibility that the soldering tip can be releasably attached to the tip holder. Then the soldering tip can be replaced quickly using the replacement module; however, for example, with wear of the soldering tip, only the tip and not the complete replacement module is replaced.

With a further possibility, the soldering tip can be integrated into the tip holder such that with wear of the soldering tip the complete replacement module is replaced. In this case it should be noted that the costs for such a replacement module are not significantly higher than for just a soldering tip.

In order to be able to manufacture the soldering tip from a relatively inexpensive material and also to facilitate a long service life of the soldering tip without reaction with soldering flux, etc., the soldering tip can exhibit an active solder material at its soldering end.

Due to the suitable dimensions of the tip holder with handle section it is already largely ensured that replacement of the replacement module is possible even with a hot soldering tip. However, this possibility can be further improved if the handle section exhibits a thermally insulating plastic material.

Such a plastic material can for example be pushed onto the rest of the tip holder and optionally shrunk on. Another possible fitting can be conceived in that a suitable handle section is sprayed onto the tip holder.

In order to be able to keep good hold of the tip holder and therefore also of the soldering tip during soldering and also when replacing the replacement module, the handle section can be anatomically shaped at least over part of its extent in the longitudinal direction of the soldering iron. Such shaping can be provided by recessed grips, grooves in the handle, etc. Similarly, projections or indentations which increase the friction can be formed in the handle section.

When handling the soldering iron and to prevent the hand of the user coming too close to the soldering tip during the soldering process or it slipping over the handle section in the direction of the soldering tip, the handle section can exhibit a tulip-shaped part extending radially outwards at its first end pointing to the soldering tip. Generally, this can be formed from the same material as the rest of the handle section. There is also the possibility that the tulip-shaped part is arranged as a separate part on the tip holder and is optionally connected to the handle section.

In order to be able to form a transition between the handle section and the end housing section as safely as possible, they can both be plugged into one another. One possibility in this connection is that the handle section at its second end exhibits a plug-in section for at least partial insertion into an end opening of the end housing section. There is also the possibility that a corresponding end of the end housing section is inserted into an opening of the handle section. The transition between the handle section and the end housing section can be formed in various ways in this region. A step can be provided in this region, which for example, causes a tactile stimulation by which a user can establish when handling the soldering iron whether he is actually holding the soldering iron in the handle section or also partially in the region of the end housing section. This sort of step can be formed at least in places along the circumference by projections on the handle section or end housing section.

The connection between the end housing section and the tip holder can be produced in various ways. One example is the screwing together of both parts. However, in order to be able to optionally release the tip holder quickly and without complication, the end housing section and the tip holder can be joined together using a rapid connection device. Such rapid connection devices are known and one example of them is a bayonet connection or similar device.

Another example of a simple rapid connection device is a plug connector.

With a soldering iron it is essential that the appropriate soldering tip is heated to certain temperatures in order to be able to carry out the actual soldering process.

In this connection there is the possibility that the heating device is arranged in the region of the soldering tip and an electrical supply is only supplied via the tip holder and the end housing section. For this purpose the plug connector can be an electrical plug connector.

A simple embodiment of such a plug connector is a plug pin protruding from the handle section in the longitudinal direction of the iron and a complementary insertion sleeve in the end housing section. The arrangement can also occur in the reverse manner. Furthermore, plug connectors with more than one plug section and corresponding insertion openings or sleeves are also possible. The plug pin exhibits insulated regions arranged in a known manner one behind the other and adjacent, via which the electrical energy can be transferred to the associated heating device.

In order to simplify insertion, not only of the plug pin, but also of the tip holder into the end housing section, the end opening of the end housing section can be expanded conically in the direction of the tip holder. The insertion end of the tip holder can be formed correspondingly.

Since the tip holder generally has larger dimensions than the actual soldering tip, it is well suited for accommodating other devices associated with the soldering iron.

In order to determine the soldering iron temperature not only in the vicinity of the heating device, a temperature sensor can be assigned to the soldering end of the soldering tip. In this way, the temperature present in the close vicinity of the soldering point can be measured and, with an appropriate device, used for the open and closed loop control of the soldering iron. The data from the temperature sensor or sensors can also be passed to the corresponding device via an electrical plug connector. Also, the heating device can be arranged directly in the soldering tip. A further temperature sensor can be positioned within the tip holder in order, for example, to switch off the heating device if the handle section becomes too hot.

In practice it is possible that a series of tip holders are used as replacement modules by a user. These tip holders can in particular be purchased singly in order to be able to use them with the other parts of the soldering iron. The invention also relates to such tip holders for a soldering iron with the features described above.

In the following an embodiment of the invention is explained in further detail based on the figure given in the drawing.

The following are shown:

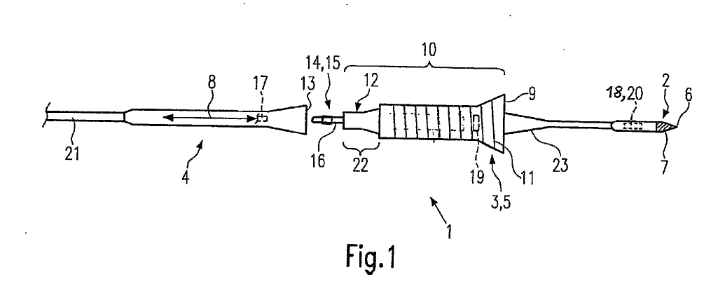

FIG. 1 a side elevation of an embodiment of a soldering iron according to the invention with an interchangeable tip holder.

FIG. 1 shows a side elevation of an embodiment of a soldering iron 1 according to the invention with tip holder 3. Apart from the tip holder 3, the soldering iron 1 exhibits an end housing section 4, in which appropriate electrical leads 21 terminate. These are only partially illustrated and provide passage of the electrical energy from a control and monitoring device, which is not illustrated and which is assigned to the soldering iron 1. In addition, temperature monitoring of the soldering iron can take place via this electrical lead 21.

The end housing section 4 extends essentially in the longitudinal direction 8 of the soldering iron and exhibits an end opening 13 on its end pointing to the tip holder 3. This is conically expanded in the direction of the tip holder.

The tip holder 3 is formed as a replacement module 5. It exhibits the actual soldering tip 2 as well as a handle section 10. The handle section 10 extends between a rapid connection device 14 and the soldering tip 2.

The rapid connection device 14 is formed as a plug connector 15 and in particular as an electrical plug connector. On the illustrated embodiment such a plug connector 15 comprises a plug pin 16, which can be inserted into a corresponding insertion sleeve 17 in the end housing section 4. The transfer of electrical energy and optionally of data or signals occurs via these said two components.

The plug pin 16 is formed from electrical contact regions arranged one behind the other in the longitudinal direction 8 of the soldering iron, which are electrically insulated from one another and are used for the transfer of the two poles of a direct electrical current to a heating device 18 arranged in the tip holder 3 or in the soldering tip 2.

Apart from the heating device 18, a temperature sensor 20 is also arranged within the soldering tip 2. The said sensor is used for monitoring the heating device and therefore for the open and optionally closed loop control of the amount of heat transferred to the soldering tip 2. Appropriate signals and data from the temperature sensor 20 can be transferred via the plug connector 15 and the electrical leads 21 to the assigned control and monitoring device of the soldering iron 1.

The handle section 10 of the tip holder 3 essentially extends between the plug connector 15 and soldering tip 2. The handle section 10 is formed from a badly thermally conducting material in order to be able to safely handle the soldering iron in this region also with the heating device 18 arranged within the tip holder 3. At its first end 9 pointing to the soldering tip 2, the handle section 10 exhibits a conically expanding tulip-shaped grip 11.

The soldering tip 2 is formed integrated with the tip holder 3, whereby it is formed at its soldering end 6 with a suitable solder-active material 7. This is used on one hand for good thermal transfer and on the other hand this material prevents a reaction of the solder material with the soldering tip 2. In the vicinity of the soldering end 6 the other temperature sensor 20 can be arranged as an alternative or an addition to a temperature sensor 19 in the tip holder. The temperature sensor 20 is used to determine the temperature at the soldering end 6 of the soldering tip 2. Also, appropriate data and signals can be transferred via the plug connector 15 and the electrical lead 21 to the control and monitoring device which is assigned to the soldering iron 1 and not illustrated.

A second end 12 of the handle section 10 located opposite the first end 9 is formed as an insertion section 22. This is formed at least partially for the conical expansion of the end opening 13 of the end housing section 4 and is inserted together with the plug pin 16 into the end opening 13 of the end housing section 4 for the rapid connection of the tip holder 3 and the end housing section. Here, the electrical connection between the individual parts of the soldering iron 1 is made by the plug pin 16 engaging the insertion sleeve 17.

The soldering tip 2 exhibits a conically shaped expansion 23 at its end pointing to the first end 9 of the handle section 10.

According to the invention, the replacement module 5 is formed as a part which is disposed of and purchased separately. If, for example, the soldering tip 2 is worn, the replacement module 5 can be discarded and substituted by a new one. This too can be used with the end housing section 4 without further adaptation. Furthermore, there is the possibility of using different replacement modules 5 with only one end housing section 4. Then different replacement modules 5 can, for example, differ in the shape of the soldering end 6, the material of the soldering tip 2 or soldering end, the performance of the electrical heating device 18, the arrangement of the temperature sensor or sensors, etc. Such replacement modules can be purchased separately.

It should be noted that the heating device 18 can also be arranged in the region of the soldering tip 2; see also, for example, the conical expansion 23 or the region of the soldering tip in which the other temperature sensor 20 is arranged.

Furthermore, there is the possibility, especially on the insertion section 22 of the handle section 10, that not only is the actual electrical plug connector fitted, but rather also the required connection technology, strain relief or a cord-guard device is provided.

1. A soldering iron comprising:
at least one interchangeable soldering tip;
a tip holder holding said tip and having a handle section;
an end housing section connected to the tip holder;
wherein the tip holder is formed with the soldering tip as a releasable replacement module which can be releasably connected to the end housing section.

2. A soldering iron according to claim 1 wherein the soldering tip is integrated in the tip holder.

3. A soldering iron according to claim 1 wherein the soldering tip exhibits a solder-active material at its soldering end.

4. A soldering iron according to claim 1 wherein the handle section exhibits a thermally insulating plastic material.

5. A soldering iron according to claim 1 wherein the handle section is sprayed onto the tip holder.

6. A soldering iron according to claim 1 wherein the handle section is anatomically shaped at least over a part of its extent in a longitudinal direction of the soldering iron.

7. A soldering iron according to claim 1 wherein the handle section exhibits a tulip-shaped grip extending radially outwards at its first end pointing to the soldering tip.

8. A soldering iron according to claim 1 wherein the handle section exhibits an insertion section at its second end for at least partially inserting into an end opening of the end housing section.

9. A soldering iron according to claim 1 wherein the end housing section and the tip holder are releasably connected together using a rapid connection device.

10. A soldering iron according to claim 9 wherein the rapid connection device is a plug connector.

11. A soldering iron according to claim 10 wherein the plug connector is an electrical plug connector.

12. A soldering iron according to claim 9 wherein the plug connector exhibits at least one plug pin protruding from the handle section in a longitudinal direction of the soldering iron and a complementary insertion sleeve in the end housing section.

13. A soldering iron according to claim 8 wherein the end opening of the end housing section is conically extended in the direction of the tip holder.

14. A soldering iron according to claim 1 wherein at least one electrical heating device or a temperature sensor is arranged within the soldering tip.

15. A soldering iron according to claim 1 wherein a temperature sensor is assigned to the tip holder (3).

16. A tip holder for a soldering iron having a housing section comprising:
a handle section;
a integrated soldering tip; and
an insertion section disposed relative to said handle section generally opposite said soldering tip; said insertion section adapted to be releasably inserted at least partially into the housing section of the soldering iron;
wherein said soldering tip is electrically connected to the housing section of the soldering iron when said insertion section is inserted into the housing section of the soldering iron.
